(19) United States
(12) Patent Application Publication
(10) Pub. No.: US 2009/0198613 A1
(43) Pub. Date: Aug. 6, 2009

(54) Method and apparatus for group decision making

(76) Inventors: Daniel Reeves, New York, NY (US); David Pennock, Monroe Township, NJ (US)

Correspondence Address: STATTLER - SUH PC, 60 SOUTH MARKET STREET, SUITE 480, SAN JOSE, CA, 95113, US

(21) Appl. No.: 12/023,881

(22) Filed: Jan. 31, 2008

(51) Int. Cl. G06Q 20/00

(52) U.S. Cl. 705/39

(57) ABSTRACT

A method and apparatus are provided for group decision making. In one example, the method includes receiving bids from group members on choices, calculating a choice winner based on the bids, calculating a pot based on the bids, redistributing the pot based on the bids, and displaying results to the group members.

### FIELD OF THE INVENTION

The present invention relates to group decision making. More particularly, the present invention relates to group decision making and finding the socially optimal choice.

### BACKGROUND OF THE INVENTION

There are plenty of established mechanisms for making group decisions, from arguing to sophisticated voting systems. Often choosing an outcome involves explicit negotiating, compromising, quid pro quo-ing, etc. Unfortunately, these mechanisms often fail to make the choice that would have maximized group welfare. There are many classic pitfalls in group decision making (like various forms of groupthink).

Group prediction is a related problem and suffers similarly from a lack of structure. Experts are hard to identify, have biases and are notoriously bad judges of their own degree of certainty. Prediction markets are an increasingly popular approach to providing incentives for information revelation and to aggregating it intelligently to predict the future.

Group decision making sometimes involves straight voting. Unfortunately, straight voting is undesirable because minorities can get trampled. For example, consider a group of three people, including a vegan and two meat eaters. The vegan strongly prefers a vegan restaurant. The meat eaters mildly prefer going to a steakhouse. In a straight vote, the vegan restaurant gets one vote from the vegan, and the steakhouse gets two votes from meat eaters. The steakhouse wins. However, that is an undesirable outcome because the meat eaters mildly prefer the steakhouse while the vegan strongly prefers the vegan restaurant. The total happiness of the group would be higher if the group goes to the vegan restaurant, even though a minority prefers the vegan restaurant. Thus, a straight vote is undesirable and unfair in such a situation.

To achieve greater social welfare and fairness in everyday decision making, there is a need for a common metric for strength of preferences (utility), and the ability to directly transfer utility from one person to another. Of course, these are the roles that money plays in society, but money is commonly eschewed for these valuable purposes in settings such as social groups and within organizations. For this reason, as well as to provide a currency for prediction markets, Yahoo!® developed yootles. A yootle is a hypothetical unit of utility or happiness.

Consider first the value of a common metric for utility. People often have no way to compare preferences. “I want” vs. “I really want” may do a poor job of comparing how much we value different options—a prerequisite for making socially optimal choices. Also, groups often have at best extremely rudimentary means for compensating the people on the losing end of decisions. Decision mechanisms with yootles payments (i.e. auctions) address both of these shortcomings through explicit compensation and preference elicitation.

Admittedly, when one is not in the habit of quantifying one's preferences, it can seem a daunting task. Nonetheless, it is quite possible to do and with practice can even become simple. When one is unsure of how much they value a particular outcome, a simple binary search is extremely effective at pinning down the indifference point. For example, a question of “Would I take that plane ticket if it were free?” might receive a response of “definitely.” A question of “Would I buy it if it cost $1000?” might receive a response of “No way.” A question of “$500?” might receive a response of “Uhh, No.” A question of “$250?” might receive a response of “Definitely.” A question of “$375?” might receive a response of “Yeah, I guess.” A question of “$438?” might receive a response of “Uhh, well . . . ” The point where one is truly torn is where that person's true utility is.

Why not just use an existing currency (like dollars) for these purposes? In fact, in some settings, an exchange rate will quickly emerge and then yootles would be money in every sense. However, some groups may want to level the playing field among a group of people of varying financial means. This is difficult to enforce but a like-minded group can achieve this property by agreeing, for example, to only use yootles for decision-making and prediction tasks. Yootles may also simply provide a more explicit framework for casting currency as a descriptor of a person's utility—a concept to which most people outside certain fields, like economics and artificial intelligence, are not accustomed. Finally, there may be various social impediments to the adoption of government currency for the purposes proposed here. Paying for influence in group decisions is not palatable to many. Also, spending one's own money in the context of one's job is avoided in corporate culture.

Yootles, just like with government currency, work because of mutual agreement. And just like with money, the whole economy is nothing but a scorekeeping system for owed favors (broadly defined). Group members start with a balance of zero and simply owe or are owed yootles. All yootles transactions, debts, and balances are tracked in a ledger system. Group decision is a key application of the yootles infrastructure.

### SUMMARY OF THE INVENTION

What is needed is an improved method having features for addressing the problems mentioned above and new features not yet discussed. Broadly speaking, the present invention fills these needs by providing a method and apparatus of group decision making. It should be appreciated that the present invention can be implemented in numerous ways, including as a method, a process, an apparatus, a system or a device. Inventive embodiments of the present invention are summarized below.

In one embodiment, a method of group decision making is provided. The method comprises receiving bids from group members on choices, calculating a choice winner based on the bids, calculating a pot based on the bids, redistributing the pot based on the bids, and displaying results to the group members.

In another embodiment, an apparatus for making a group decision is provided. The apparatus comprises a transmitter device configured to receive bids from group members on choices, a processor device configured to calculate a choice winner based on the bids, to calculate a pot based on the bids, and to redistribute the pot based on the bids, and a display device configured to display results to the group members.

In still another embodiment, a computer readable medium carrying one or more instructions for making a group decision is provided. The one or more instructions, when executed by one or more processors, cause the one or more processors to perform the steps of receiving bids from group members on choices, calculating a choice winner based on the bids, calculating a pot based on the bids, redistributing the pot based on the bids, and displaying results to the group members.

The invention encompasses other embodiments configured as set forth above and with other features and alternatives.

### BRIEF DESCRIPTION OF THE DRAWINGS

The present invention will be readily understood by the following detailed description in conjunction with the accompanying drawings. To facilitate this description, like reference numerals designate like structural elements.

FIG. 1 shows apparatuses of a group decision making system, in accordance with an embodiment of the present invention;

FIG. 2A is a system for group decision making including two apparatuses receiving input, in accordance with an embodiment of the present invention;

FIG. 2B is the system for the group decision making of FIG. 2A including the two apparatuses receiving results, in accordance with an embodiment of the present invention;

FIG. 3A is a system for group decision making including three apparatuses receiving input, in accordance with an embodiment of the present invention;

FIG. 3B is the system for group decision making of FIG. 3A including the three apparatuses receiving results, in accordance with an embodiment of the present invention;

FIG. 4 is a flowchart for a method of making group decisions, in accordance with an embodiment of the present invention; and

FIG. 5 is a flowchart for a method of making group decisions with minimal cognitive overhead, in accordance with an embodiment of the present invention.

### DETAILED DESCRIPTION OF THE INVENTION

An invention for a method and apparatus for group decision making is disclosed. Numerous specific details are set forth in order to provide a thorough understanding of the present invention. It will be understood, however, to one skilled in the art, that the present invention may be practiced with other specific details.

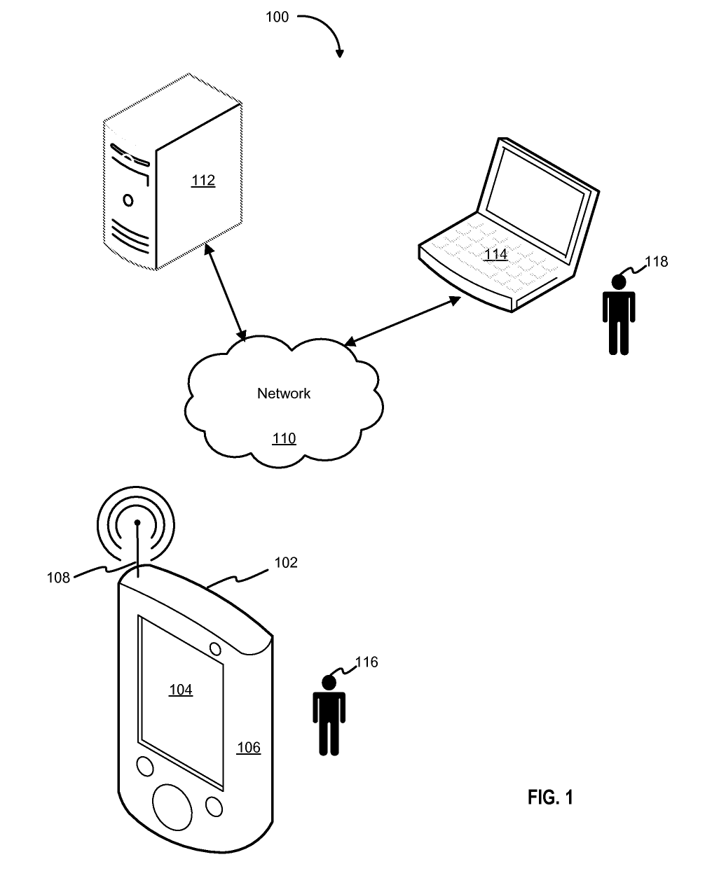

FIG. 1 shows apparatuses of a group decision making system 100, in accordance with an embodiment of the present invention. This particular group decision making system 100 includes devices for explanatory purposes. A group decision making system may include other devices not illustrated here.

This group decision making system 100 includes a network 110 that couples various devices to one another. The network 110 may be any combination of appropriate networks, including a Bluetooth® network, a personal area network (PAN), a local area network (LAN), a wide area network (WAN), a mobile device network or a wireless network, among network types. The group decision making system 100 includes a mobile device 102, a laptop computer device 114 and a server device 112. In this example, a group member 116 operates the mobile device 102; another group member 118 operates the laptop computer device 114.

The mobile device 102 is discussed here in further detail to illustrate components of a group decision making device that are common among such devices generally. The mobile device 102 includes a processor device 106, a transmitter device 108 and a display device 104. The processor device 106 carries out certain processing locally at the mobile device 102. Such processing may take the place or work in conjunction with processing that may take place at the server device 112. The transmitter device 108 receives and sends data to other devices in the network 110. The transmitter device 108 may be a radio frequency (RF) antenna capable of sending and receiving data over the network 110. Such transmission may take place with one or more other mobile devices 102 using Bluetooth®; in such an example, each mobile device 106 would perform processing locally using each processing device 106.

A device is hardware, software or a combination thereof. The devices of a group decision making device are each configured to carry out one or more steps of the method of group decision making according to the present invention. The method is discussed here with reference to the figures.

The combination of networking possibilities are too numerous to discuss in detail here. FIG. 1 provides an illustration of just a few of many possible networking configurations for group decision making.

The method of group decision making involves decision auction generalized for n-players. A decision auction is a budge balanced mechanism based on the Vickrey-Clarke-Groves Mechanism (VCG) but modified by redistributing the VCG surplus after bids are received and a winner is calculated. The redistribution of the VCG surplus increases group fairness with limited impact on any incentive compatible. VCG is a well-known group decision-making mechanism and will not be discussed in detail here. Basically, VCG can be applied whenever group members can specify their full preferences and when finding the socially optimal choice given those preferences is computationally feasible.

The decision auction redistributes the surplus of a group decision. After making the VCG payments each group member receives back a piece of the surplus from a pot in proportion to the difference between their highest bid and their bid for the winning option. Group members whose highest bid was placed for the winning option will thus not receive any payout. Accordingly, losers get compensated in proportion to how badly they wanted some other result. If someone is neutral among the options and bids zero across the board, they will not receive any payment. On the other hand, someone who really wanted one of the losing options will receive a higher payout, provided that at least one person was pivotal in the auction. If no one is pivotal, then, like straight VCG, the mechanism does not require any payments. Even in the simple two-person case with uniform types, the decision auction is efficient even when played strategically.

The redistribution of payments amongst the losers means that this mechanism is not incentive compatible. For example, placing your highest bid for something you know will lose will garner you more of the redistributed surplus.

Likewise, if you suspect you will be pivotal and may need to pay close to your full bid to influence the outcome, you may prefer to reduce your bid in order to lose (have a less preferred option chosen) and get compensated. However, a group member cannot have greater influence on the chosen outcome by changing their bids. A group member can only capitalize on losing. This can be considered a form of partial incentive compatibility in the sense that, among a small group of people who care foremost about finding the social optimum, reasonable group members are unlikely to try to capitalize off the rest of the group. This is in contrast to straight voting, for example, where strategizing may be required to keep your vote from being wasted.

The decision auction also retains incentive compatibility in a different sense: a sufficiently risk-averse group member, assuming a minimally diffuse distribution of others' preferences, will not inflate bids since doing so entails a risk of a negative utility (paying more for an outcome than its worth). Truthful bidding is a minimax strategy in the decision auction. A minimax strategy is found by considering for each strategy the lowest possible utility if that strategy is followed (as if the other players cared for nothing but to harm you) and picking the one for which this minimum is maximized. In other words, it is the strategy which maximizes worst-case utility.

When dealing with mechanisms that are not incentive compatible, it is useful to introduce some notion of the degree of incentive compatibility of the mechanism. To these ends, it is desirable to measure how much a group member stands to gain by bidding its best response to truthful bidding.

In one embodiment, a bunch of people are physically located in the same room and want to conduct an auction or make a group decision or place wagers or run some other mechanism. Each has a mobile device of some kind: a phone or other device. Each participant submits his or her own bid or vote or bet into his or her own device. The auction (or group decision or wager or other mechanism) is conducted wirelessly over Bluetooth® or other protocol. All the devices coordinate to compute the outcome of the mechanism, and broadcast out the results back to everyone. Payments are automatically transferred electronically among the participants as dictated by the outcome.

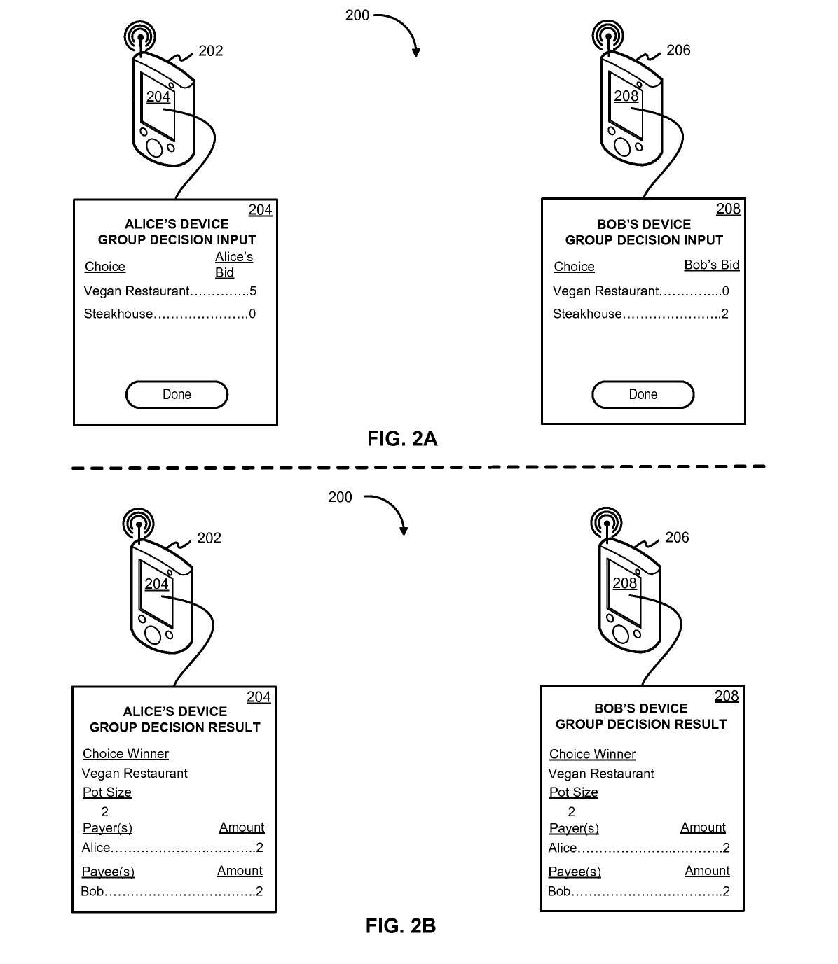

FIG. 2A is a system 200 for group decision making including two apparatuses receiving input, in accordance with an embodiment of the present invention. In this group decision making system 200, Alice's mobile device 202 is wirelessly coupled Bob's mobile device 206. These mobile devices may use Bluetooth® technology to communicate with each other. Alice and Bob are trying to decide between two restaurants, a vegan restaurant and a steakhouse. Other examples of decisions, besides people deciding a restaurant, are two roommates deciding who gets the bigger room and roommates deciding who must do a certain chore. Each group member inputs a bid into their respective mobile devices. A bid represents the utility for a group member, in other words, how much a group member cares about a choice. The group decision making system 200 is agnostic about the currency. This particular example happens to be using yootles. However, the group members can carry out the mechanism with any currency, including dollars.

The mobile devices receive the inputs but do not reveal the inputs of the other group member. Using Alice's display device 204, Alice inputs a bid of five (5) into her mobile device 202 for the vegan restaurant, her desired restaurant. Alice inputs zero (0) for the steakhouse, her undesired restaurant. Alternatively, if a group member inputs no bid for the steakhouse, the implicit bid is zero. A group member may also input a negative number for an undesired choice. The system 200 treats the lowest negative number as if that bid is zero and normalizes all other bids accordingly. After inputting her bids, Alice may then press the “Done” button.

Using Bob's display device 208, Bob inputs a bid of two (2) into his mobile device 206 for the steakhouse, his desired restaurant. Bob inputs zero (0) for the vegan restaurant, his undesired restaurant. After inputting his bids, Bob may then press the “Done” button. After all the group members are done, each device performs the necessary calculations to obtain the results.

FIG. 2B is the system 200 for the group decision making of FIG. 2A including two apparatuses receiving results, in accordance with an embodiment of the present invention. Each mobile device calculates the results and displays the results to the respective group member. The choice winner is the choice receiving the highest number of bids. The winner is also known as the socially optimal choice. In this case, the choice winner is the vegan restaurant because it received 5 bids while the steakhouse received only 2 bids.

Alice got her first choice. The winner Alice pays the loser Bob the loser's bid. The loser's bid here is two (2), which is also the pot size. Alice, the payer, pays two (2) to the pot because Alice made Bob two (2) less happy than he would have been had Alice not participated. Bob pays nothing because Alice received exactly the choice Alice wanted. Bob, the payee, receives the entire pot of two (2) because Bob is the only group member who did not get the choice he wanted.

As can be expected, with more people, there are more options. Thus, the group decision making system becomes more complicated.

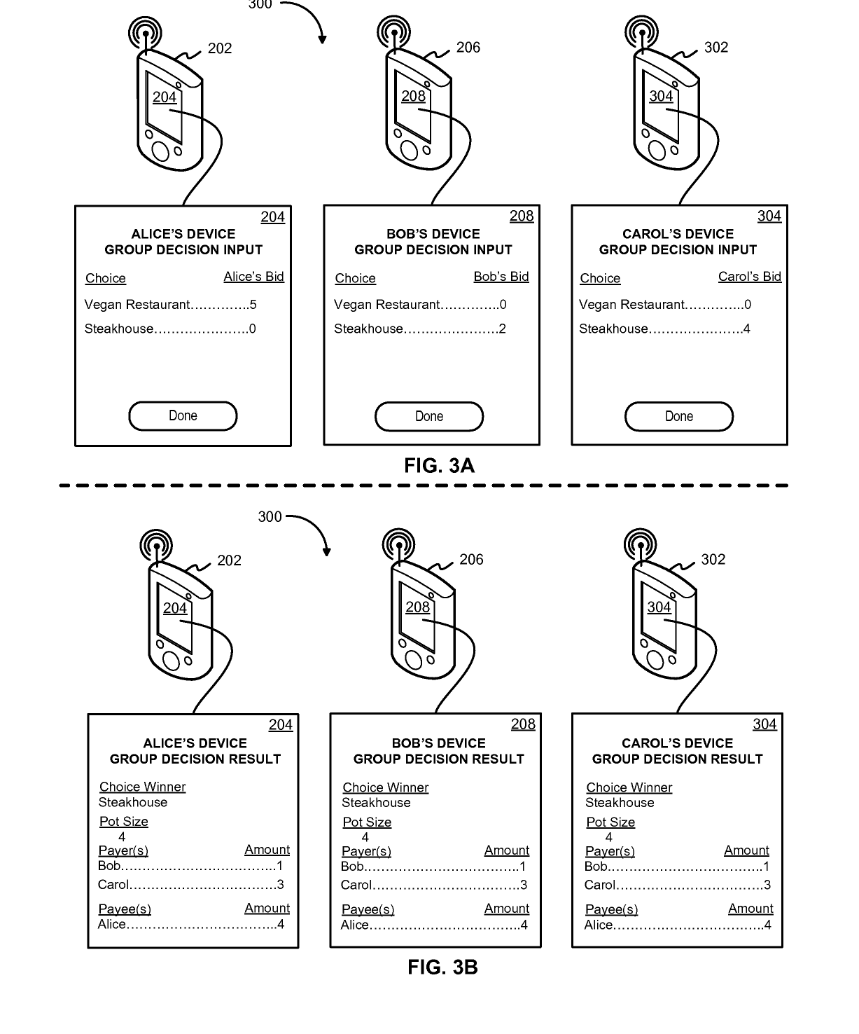

FIG. 3A is a system 300 for group decision making including three apparatuses receiving input, in accordance with an embodiment of the present invention. The group from FIG. 2A has added another group member Carol, which makes the group have three people. Alice and Bob both bid as they did in FIG. 2A. Using Carol's display device 304, Carol inputs a bid of four (4) into her mobile device 302 for the steakhouse, her desired restaurant. Carol inputs zero (0) for the vegan restaurant, her undesired restaurant. After inputting her bids, Carol may then press the “Done” button.

FIG. 3B is the system 300 for group decision making of FIG. 3A including the three apparatuses receiving results, in accordance with an embodiment of the present invention. Each mobile device calculates the results and displays the results to the respective group member. The choice winner is the choice receiving the highest number of bids. The winner is also known as the socially optimal choice. In this case, the choice winner is the steakhouse because it received 6 bids while the vegan restaurant received only 5 bids.

The payments are now calculated. Each group member pays the externality that person imposes on the others. To determine the externality, the system 300 determines what everybody else would have done without that particular person. The system 300 determines how happy everybody else would have been had the person not participated. If the person was not pivotal to the outcome, the person pays nothing. On the other hand, if the person was pivotal to the outcome, the person pays the difference between everybody else's utility with the person participating and without the person participating. The payments go into the pot. The system 300 redistributes the payments from the pot to each group member in proportion to how disappointed each group member is. The level of disappointment is calculated based on each group member's bid relative to the others. In other words, each group member gets a portion of the pot in proportion to how much each group member would have preferred some other choice besides the choice winner.

Both Bob and Carol got their first choice. Alice pays nothing to the pot because, without her, Bob and Carol would have unanimously deciding on the steakhouse. Alice was not pivotal. In other words, Alice did not change the outcome. However, Bob and Carol are each going to pay something to the pot because each of their bids was pivotal.

Without Bob, Alice would have won because the bids would have been Alice's five (5) for the vegan restaurant and Carol's four (4) for the steakhouse. Instead, Bob put his bid of two (2) in for the steakhouse and caused the steakhouse to be chosen. Everyone else's utility for the steakhouse was four (4), in other words, Carol's bid. The difference between the utilities is five (5) minus four (4) equals one (1). In other words, Bob decreased the happiness of the group, besides Bob, from five (5) to four (4). One (1) is the amount that Bob pays into the pot.

Without Carol, Alice would have won because the bids would have been Bob's five (5) for the vegan restaurant and Bob's two (2) for the steakhouse. Instead, Carol put his bid of four (4) in for the steakhouse and caused the steakhouse to be chosen. Everyone else's utility for the steakhouse was two (2), in other words, Bob's bid. The difference between the utilities is five (5) minus two (2) equals three (3). In other words, Carol decreased the happiness of the group, besides Bob, from five (5) to two (2). Three (3) is the amount that Carol pays into the pot.

With Bob's and Carol's payments into the pot, the pot size is now four (4). The four (4) is what is redistributed appropriately among the group members. Alice got zero utility from the steakhouse and would have gotten five (5) from the vegan restaurant. Alice gets five (5) shares of the pot. Bob and Carol each get zero (0) shares of the pot because they each got their first choice and each bid zero (0) for the vegan restaurant. Accordingly, Alice receives all of the pot, in other words, a payment of four (4).

In another example, more than one person could conceivably get a piece of the pot. Each group member gets a payment proportional to how much more utility that person could have gotten from their first choice. That's how many shares each group member receives. Maybe Alice gets her five (5) shares while another group member gets three (3) shares. In such a case, the total number of shares is eight (8). The pot is divided by eight. Alice gets ⅝ of the pot. The other group member gets ⅜ of the pot.

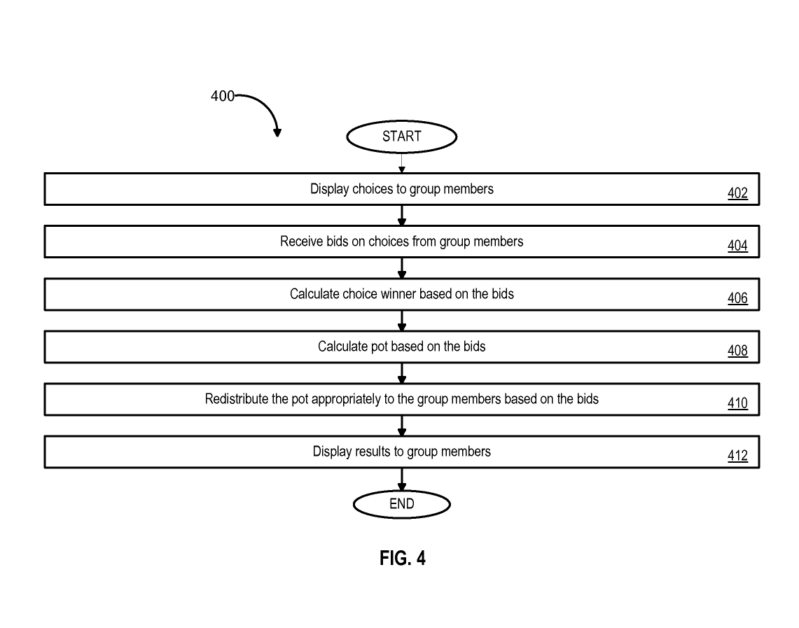

FIG. 4 is a flowchart for a method 400 of making group decisions, in accordance with an embodiment of the present invention. The method 400 starts in step 402 where the system displays choices to group members. In step 303, the system receives group member bids on the choices. Once all the bids are in, the method proceeds to step 406 where the system calculates the choice winner based on the bids. Next, in step 408, the system calculates the pot based on the bids. The method then moves to step 410 where the system redistributes the pot appropriately to the group members based on the bids. In step 412, the system displays the results to the group members. The method 400 is then at an end.

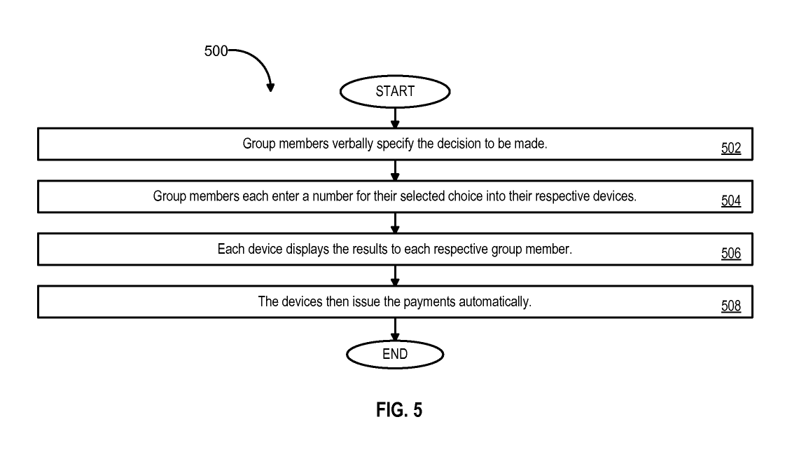

FIG. 5 is a flowchart for a method 500 of making group decisions with minimal cognitive overhead, in accordance with an embodiment of the present invention. The idea is similar to that of “drawing straws” or picking one person (or picking one option where there's a one-to-one correspondence between options and people). The method 500 starts in step 502 where group members verbally specify the decision to be made. Next, in step 504, group members each enter a number for their selected choice into their respective devices. The devices automatically create an auction based on the proximity in time and of the bids being entered. The method then moves to step 506 where, as soon as all bids are in, each device displays the results to each respective group member. In step 508, the devices then issue the payments automatically. The method is then at an end. The idea is to be able to have these kinds of decision auctions where the interaction required of a user consists of nothing more than entering one number. Without the proximity-awareness that Bluetooth® provides, additional cognitive steps are required of the group members, like choosing and entering a name for the auction. Similar interfaces are possible for other mechanisms, such as betting games.

### Computer Readable Medium Implementation

Portions of the present invention may be conveniently implemented using a conventional general purpose or a specialized digital computer or microprocessor programmed according to the teachings of the present disclosure, as will be apparent to those skilled in the computer art.

Appropriate software coding can readily be prepared by skilled programmers based on the teachings of the present disclosure, as will be apparent to those skilled in the software art. The invention may also be implemented by the preparation of application-specific integrated circuits or by interconnecting an appropriate network of conventional component circuits, as will be readily apparent to those skilled in the art.

The present invention includes a computer program product which is a storage medium (media) having instructions stored thereon/in which can be used to control, or cause, a computer to perform any of the processes of the present invention. The storage medium can include, but is not limited to, any type of disk including floppy disks, mini disks (MD's), optical disks, DVDs, CD-ROMs, micro-drives, and magneto-optical disks, ROMs, RAMs, EPROMs, EEPROMs, DRAMs, VRAMs, flash memory devices (including flash cards), magnetic or optical cards, nanosystems (including molecular memory ICs), RAID devices, remote data storage/archive/warehousing, or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, and user applications. Ultimately, such computer readable media further includes software for performing the present invention, as described above.

Included in the programming (software) of the general/specialized computer or microprocessor are software modules for implementing the teachings of the present invention, including but not limited to receiving bids from group members on choices, calculating a choice winner based on the bids, calculating a pot based on the bids, redistributing the pot based on the bids, and displaying results to the group members, according to processes of the present invention.

### ADVANTAGES

The group decision mechanism of the present invention involves VCG payments plus a modification to redistribute the VCG surplus after bids are received and a winner is calculated. The group decision mechanism may be carried out between two or more people on any type of network. The mechanism is agnostic to currency. Accordingly, group members may make group decisions using readily available user devices, such as mobile devices, and may quickly determine the socially optimal choice.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. A method of group decision making, the method comprising:
receiving bids from group members on choices;
calculating a choice winner based on the bids;
calculating a pot based on the bids;
redistributing the pot based on the bids; and
displaying results to the group members.

2. The method of claim 1, wherein the group decision making is agnostic to currency.

3. The method of claim 1, further comprising coupling group member devices over a network, wherein each group member device is a mobile device.

4. The method of claim 3, wherein the network is at least one of a Bluetooth® network and a personal area network.

5. The method of claim 4, wherein the receiving bids comprises receiving a bid into each mobile device from each respective group member.

6. The method of claim 1, wherein the choice winner is a choice that receives the highest number of bids from the group members, and wherein the choice winner is the socially optimal choice.

7. The method of claim 1, wherein the calculating the pot comprises calculating payments from each group member, wherein the method further comprises calculating for each group member an externality that each group member imposes on other group members.

8. The method of claim 7, wherein the calculating the externality for each group member comprises receiving payments from group members who were pivotal to the outcome, and wherein the calculating the externality from each group member further comprises receiving no payments from group members who were not pivotal to the outcome.

9. The method of claim 1, wherein the redistributing the pot comprises redistributing the payments from the pot to each group member in proportion to how much each group member would have preferred some other choice besides the choice winner.

10. The method of claim 1, wherein the redistributing the pot comprises redistributing the pot to more than one group member, wherein the redistributing the post further comprises sending each group member a payment proportional to how much more utility that group member could have gotten from their first choice.

11. An apparatus for making a group decision, the apparatus comprising:
a transmitter device configured to receive bids from group members on choices;
a processor device configured to calculate a choice winner based on the bids, to calculate a pot based on the bids, and to redistribute the pot based on the bids; and
a display device configured to display results to the group members.

12. The apparatus of claim 11, wherein the apparatus is configured to be agnostic to currency.

13. The apparatus of claim 11, wherein the apparatus is a mobile device, and wherein the apparatus is configured to be coupled with group member devices over a network, wherein each group member device is a mobile device.

14. The apparatus of claim 13, wherein the network is at least one of a Bluetooth® network and a personal area network.

15. The apparatus of claim 14, wherein each mobile device is configured to receive a bid from each respective group member.

16. The method of claim 11, wherein the processor device is further configured to calculate the choice winner as being a choice that receives the highest number of bids from the choices, and wherein the choice winner is the socially optimal choice.

17. The method of claim 11, wherein the processor device is further configured to calculate the pot by calculating payments for each group member, wherein the processor device is further configured to calculate for each group member an externality that each group member imposes on other group members.

18. The method of claim 17, wherein the processor device is further configured to receive payments from group members who were pivotal to the outcome, and wherein the processor device is further configured to receive no payments from group members who were not pivotal to the outcome.

19. The method of claim 11, wherein the processor device is further configured redistribute the payments from the pot to each group member in proportion to how much each group member would have preferred some other choice besides the choice winner.

20. The method of claim 11, wherein the processor device is further configured redistribute the pot to more than one group member, wherein each group member receives a payment proportional to how much more utility that group member could have gotten from their first choice.

21. A computer readable medium carrying one or more instructions for making a group decision, wherein the one or more instructions, when executed by one or more processors, cause the one or more processors to perform the steps of:
receiving bids from group members on choices;
calculating a choice winner based on the bids;
calculating a pot based on the bids;
redistributing the pot based on the bids; and
displaying results to the group members.
